(19) United States
(12) Patent Application Publication
(10) Pub. No.: US 2008/0022821 A1
(43) Pub. Date: Jan. 31, 2008

(54) SHEET PUNCHING AND EMBOSSING MACHINE

(75) Inventor: Frank Hendrik, Heidelberg (DE)

Correspondence Address: HEIDELBERGER DRUCKSMASCHINEN AKTIENGESELISCHAFT;C/O KEATING & BENNETT, LLP, 8180 GREENSBORO DRIVE, SUITE 850, MCLEAN, VA, 22102, US

(73) Assignee: HEIDELBERGER DRUCKMASCHINEN AG, Heidelberg (DE)

(21) Appl. No.: 11/769,907

(22) Filed: Jun. 28, 2007

(30) Foreign Application Priority Data
Jul. 26, 2006 (DE) 10 2006 034 509.6
Jul. 26, 2006 (DE) 10 2006 034 511.8
Mar. 26, 2007 (DE) 10 2007 014 313.5

(51) Int. Cl. B26F 1/40

(52) U.S. Cl. 83/277

(57) ABSTRACT

A sheet punching and embossing machine for the processing of sheets includes several punching and/or embossing stations. Each of the punching and/or embossing stations includes one platen fixed to the frame and one movable platen. Furthermore, a transport device for transporting the sheets through the individual processing stations is provided. The movable platens are each actuated by separate drive units by a position governing circuit so that the stroke movement of the movable platen of each punching and/or embossing station can be individually adjusted.

### BACKGROUND OF THE INVENTION

1. Field of the Invention

The present invention relates to a sheet punching and embossing machine.

2. Description of the Related Art

Punching refers to a cutting with closed, geometrical forms, which can be circular, oval, or polygonal, as well as any number of special shapes. Practices in the post processing of a print job, such as punching with hollow punch, rounding corners, and register punching, are also in this field. The punching is performed against a base or against a punch, and sometimes it also involves shearing processes (cf. Post processing, Training Manual for Bookbinders, Bundesverband Druck e.V. 1996, page 351 et seq.).

Packaging materials, such as paper, cardboard, paperboard, or corrugated cardboard, are primarily punched in sheet form. During the punching process, however, groove lines or blind imprints may also be provided into the finished sheets. This complex process requires sheets to be individually punched. Since the end products are packages with demanding technical and graphical requirements (such as those for cosmetics, cigarettes, medicines, foods, etc.), special requirements are placed not only on the packaging materials themselves, but on punching dies having minimal tolerances, and extremely precise and reliable punching machines are also required for optimal results.

These demands are most efficiently satisfied using flatbed punches. The printed sheets are stacked on a pallet and fed to the punch. In the machine, the sheets being punched are first separated into single sheets, then oriented accurately in an orienting mechanism, picked up by a gripping cart and precisely positioned in the punching mechanism. The gripping carts may be moved through the machine on endless chains or may be driven by linear drives.

The punching mechanism typically includes a stationary table provided with a counterplate and a table provided with punching and grooving dies, which is movable up and down in a direction perpendicular to the counterplate by a lifting drive. Due to this up and down movement, the sheets that are fed through the space between the table surfaces are punched into finished copies, and at the same time, the grooves required for folding are indented.

In a subsequent breakaway mechanism, the waste is mechanically removed via breakaway dies. Finally, depending on the machine outfitting, the punched copies can be separated in a copy separation mechanism.

A drive for a sheet punching and embossing machine is disclosed in DE 30 44 083 A1. The machine described therein includes a fixed lower table and an upper table which is movable up and down for punching sheets of paper, cardboard, and other packaging materials. The movement of the upper table is provided by rollers which are arranged on two eccentric shafts disposed above the table. The upper table is disposed with spring force against the rollers on the eccentric shaft. Through a rotary movement of the eccentric shafts, the upper table is moved vertically toward the lower table. The eccentric drive unit produces a substantially sinusoidal lifting movement of the upper table.

Another drive for a sheet punching and embossing machine is disclosed in DE 33 13 790 C2. The platen punch press includes a first platen fixedly arranged in a machine frame and a second platen arranged to be movable toward the first platen. The second platen is movable toward the first platen via four bent levers which articulate therewith. The bent levers are each buttressed against the machine frame by a support joint and are actuated by a cam drive.

In the known drive units, the lifting motion is coupled to the delivery motion due to a common drive unit. The drawback to this solution is the design-dictated use of heavy masses in the area of the eccentric or bent lever system and the poor flexibility in the control of the lifting motion relative to the delivery motion, thus, preventing optimization of the punching process.

An alternative solution for applying the punching force is described in DE Utility Model 76 11 968. However, the sheets are not delivered in DE Utility Model 76 11 968. A hydraulic cylinder located in a lower portion of the machine and arranged centrally to the punching die acts on the upper table of a punch using a symmetrical lever and two guided rods. The drawback of this solution is the cumbersome construction for the transmission of force and an inability the accurately adjust the punching force.

### SUMMARY OF THE INVENTION

To overcome the problems described above, preferred embodiments of the present invention provide a sheet punching and embossing machine having several processing stations, and in which the lift stroke of a movable die is independent from the delivery movement of the sheet.

In a preferred embodiment of the present invention, movable dies are moved by separate drive units. This enables the separate drive units to be separately actuated. Thus, with a position governing circuit, the stroke movement of each movable die can be individually actuated.

The separate drive units may be hydraulic cylinders. So as to avoid the necessity of providing the pressure connection ports on the cylinders, the piston is secured to the movable die and the cylinder is secured to the frame. The movable die may be moved by one or more hydraulic cylinders. When several cylinders are provided, unevenness of the packaging material or local material deficiencies can be compensated for, especially when the hydraulic cylinders can be freely positioned on the movable die. Individual position and pressure regulation also shortens the setup time when changing print jobs. In this case, it is possible to drive either the upper table or the lower table via the hydraulic cylinders.

Preferably, the individual settings of the dies are determined as a function of a global machine angle, which is provided, for example, by a setpoint generator.

For the position control, for example, a resistance control may be used in which the flow into the cylinders is regulated by valves.

In a preferred embodiment, a displacement control is used for the position control, which regulates the flow into the cylinders by a variable displacement pump. By eliminating the valves for regulating the flow of pressure medium into and out of the cylinders, it is possible to improve the efficiency of the machine.

In another preferred embodiment, no hydraulics are used. The lift motion of the movable die is provided via eccentric drive units or bent lever drive units. The major power flow is provided from the press drive to the eccentric shafts. Mechanical synchronization is required for only a small portion of the power. Advantageously, the synchronization occurs via a connection gearing between press drive and a king shaft.

In another preferred embodiment, the synchronization is provided via the individual drive motors which are controlled as servo drives. In this manner, a simple synchronization is provided.

Combinations of mechanically and hydraulically driven dies may also be provided.

In another preferred embodiment, the transport device for transporting the sheets through the individual processing stations is a linear drive.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 shows the basic layout of a sheet punching and embossing machine in schematic representation.

FIG. 2 shows a punching and embossing station with hydraulically operated movable die in schematic representation.

FIG. 3 shows the individual motion sequences of several punching and embossing stations with hydraulically operated movable dies in schematic representation.

FIG. 4 shows a schematic representation of the control system of the individual motion sequences.

FIG. 5 shows a schematic representation of mechanically operated press drive units.

FIG. 6 shows a schematic representation of the synchronization of mechanically driven press drive units.

FIG. 7 shows a closed feedback control circuit for actuating the mechanically drive press drive units.

### DETAILED DESCRIPTION OF PREFERRED EMBODIMENTS

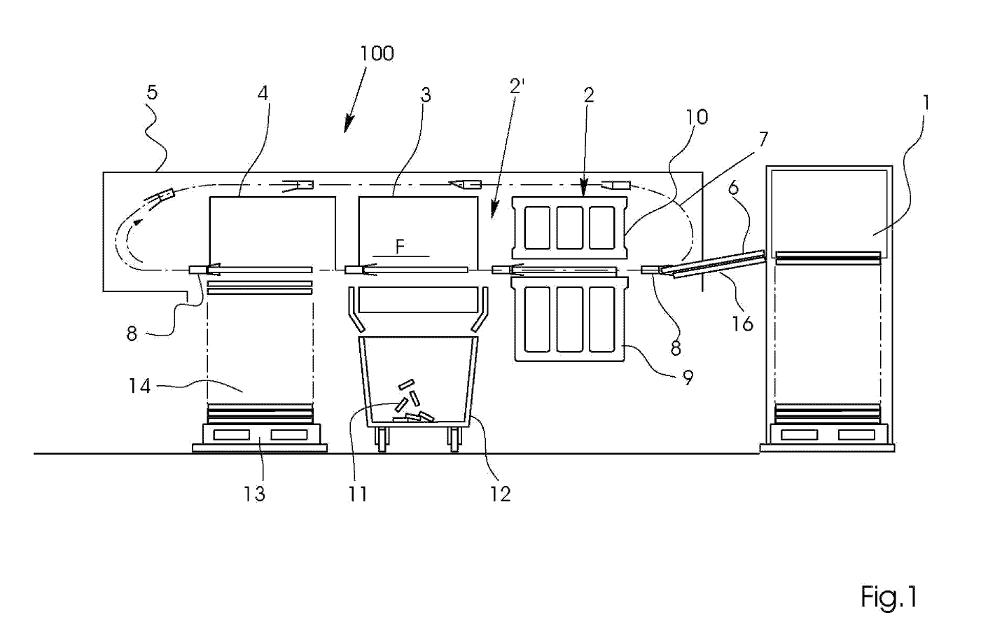

FIG. 1 shows the basic layout of a sheet punching and embossing machine 100 for the punching, breaking-off and stacking of sheets of paper, cardboard, or other stock material. The punching and embossing machine 100 includes, for example, a feeding attachment 1, two punching and/or embossing stations 2, 2′, a breaking-off station 3 and a delivery attachment 4, being supported and enclosed in a common machine housing 5.

The sheets 6 are fed individually from a stack by a feeding attachment 1 and fed via a feed table 16 to the sheet punching and embossing machine 100, grasped by grippers at their front edge and intermittently pulled through the various stations 2, 2′, 3 and 4 of the punching and embossing machine 100 in the sheet delivery direction F. The grippers are fastened to gripping rods, which are fastened to gripping carts 8, which are in turn attached to a transport system 7.

The punching and/or embossing stations 2, 2′ include a lower table 9 and an upper table 10. The lower table 9 is fixedly mounted in the machine frame and provided with a counterplate for punching blades, not shown. The upper table is mounted so as to be vertically movable up and down and provided with punching and grooving blades.

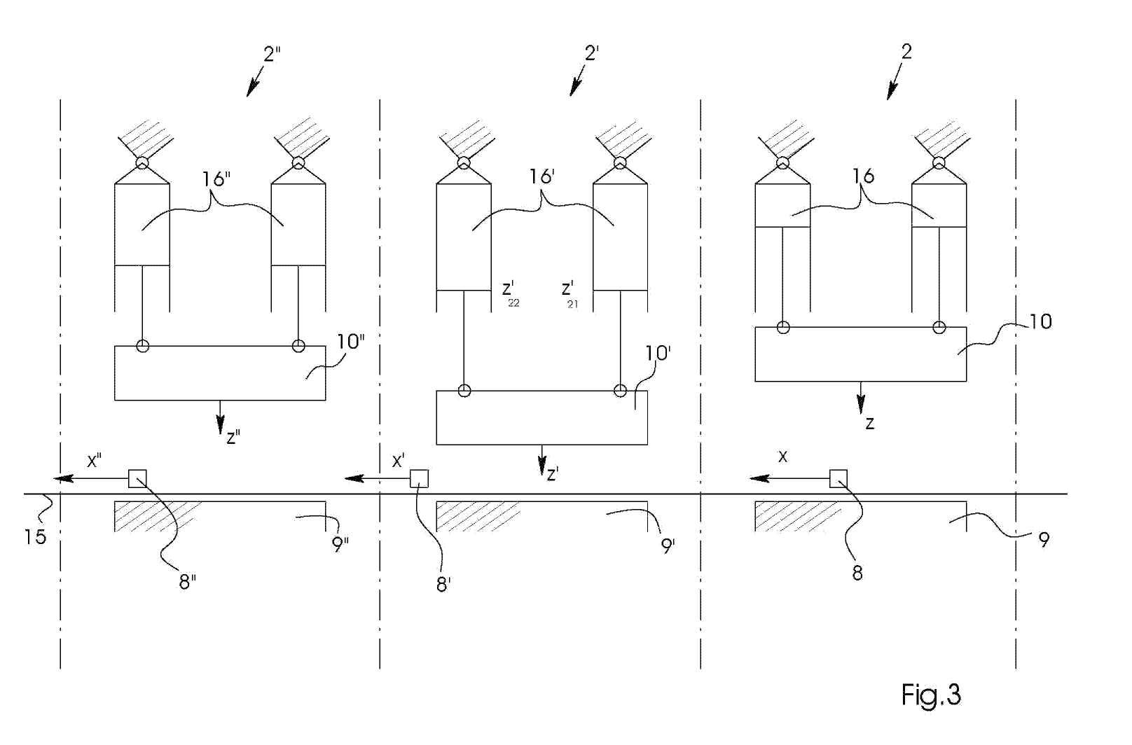

The gripper carts 8 including the grippers transport the sheet 6 (in directions x, x′, x″ shown in FIG. 3) from the punching and embossing stations 2, 2′ to the breakaway station 3, which includes breakaway dies. In the breakaway station 3, the unneeded scraps are pushed downward from the sheet by the breakaway dies, so that the scraps 11 drop into a container cart 12 positioned under the station.

From the breakaway station 3, the sheet is transported to the delivery attachment 4, where the sheet is either stacked or separated into individual copies at the same time. The delivery attachment 4 may also include a pallet 13, on which the individual sheets are stacked to form a pile 14. When the pile reaches a desired height the pallets with the stacked sheets 14 disposed thereon is transported away from the area of the punching and embossing machine 100.

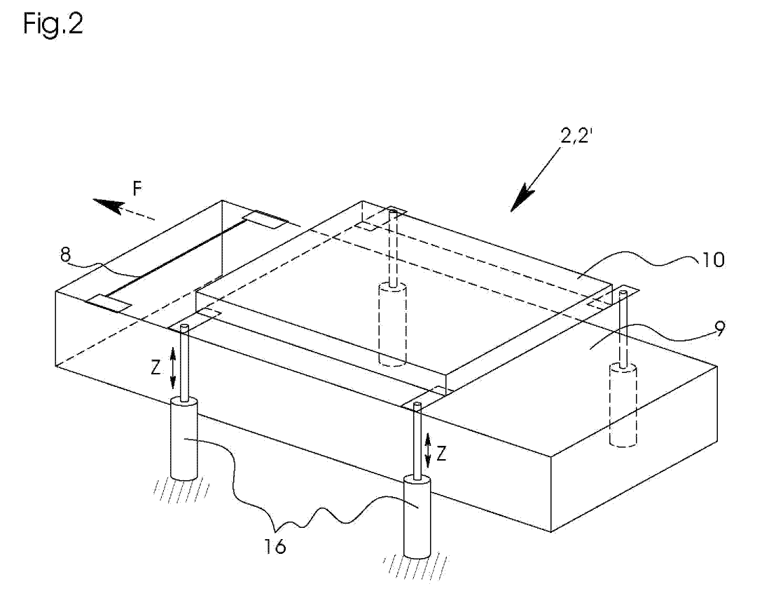

FIG. 2 shows one of the processing stations 2, 2′, for example, a punching or embossing station, of a sheet punching and embossing machine 100 according to preferred embodiments of the present invention. The sheet 6 being processed is transported by the conveying device 7, 8 (8, 8′, 8″ shown in FIG. 3) in the conveying direction F of the sheet into the processing station 2, 2′. The processing stations have a movable upper table 10 and a lower table 9 fixed to the housing. Four hydraulic cylinders 16 for applying a punching force to the punching die are located in the lower portion of the machine. The hydraulic cylinders 16 are connected to the upper table 10 and are mounted in the machine frame of the sheet punching and embossing machine. The hydraulic cylinders 16 produce a punching stroke in the direction Z, by which the upper table 10 is moved against the fixed lower table 9.

FIG. 3 shows the individual motion sequences of several processing stations 2, 2′, 2″ with hydraulically operated movable tables. The upper tables 10, 10′, 10″ are each driven in the directions z, z′, z″ by one or more hydraulic cylinders 16, 16′, 16″ (in the preferred embodiment, two hydraulic cylinders are shown) toward the lower tables 9, 9′, 9″. So as not to include the pressure connection ports on the cylinders, the piston is secured to the moving part (here, the upper table 10, 10′, 10″), and the cylinder is secured to the machine frame. The upper tables 10, 10′, 10″ each describe a motion in the coordinate Z, while the motions z, z′, z″ can be controlled individually from one upper table to another, depending on the job and the specific operation being performed in the processing station.

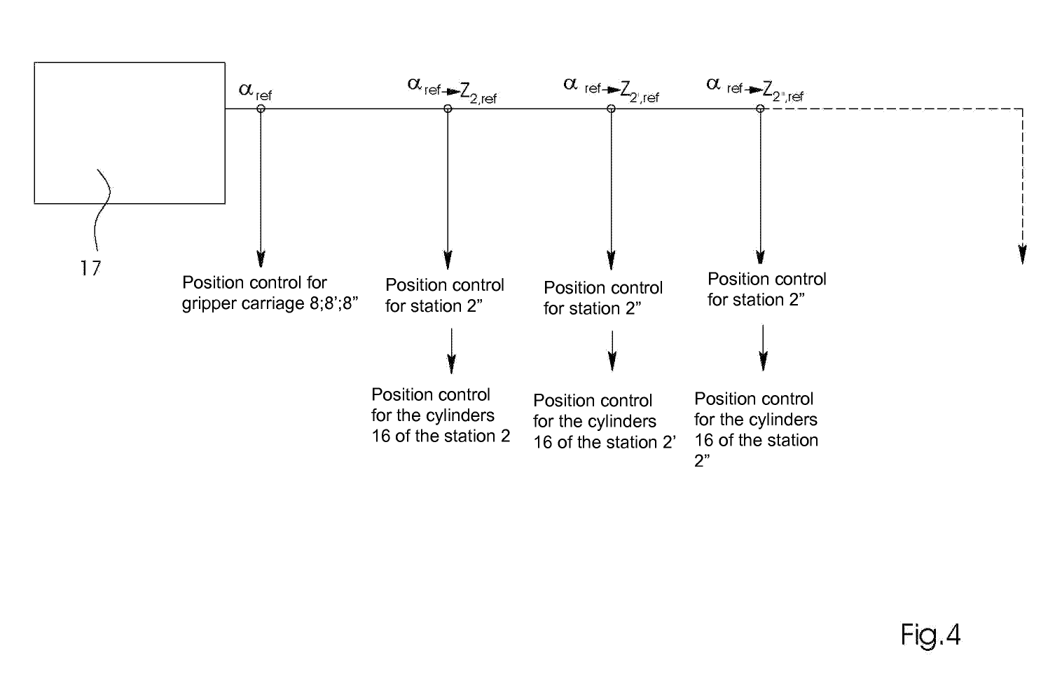

In FIG. 4, the control system of the individual components is schematically shown. From a setpoint generator 17, which generates the global machine reference angle αREF, referencing the machine clock and the machine positions, a nominal reference value is individually generated:

### Z_{2,REF} for the upper table 10 of station 2,

### Z_{2′REF} for the upper table 10′ of station 2′,

### Z_{2″,REF} for the upper table 10″ of station 2″,

and so forth.

Starting from this central setpoint generator 17, therefore, a reference value or “machine angle” is defined, which provides the input variable for the feedback control of the individual stations, as well as the drive system, which may be defined, for example, by several linear drives. The upper tables are then regulated to the setpoint reference produced in the position feedback control circuit. The controlling of such individual hydrostatic drive units is known and described, for example, in the hydraulics lecture notes: Murrenhoff, H.: Fundamentals of Fluidics, Vol. 1: Hydraulics, 4^{th} ed. 2005; Murrenhoff, H.: Servohydraulics, 2^{nd} ed. 2002.

Instead of a movable upper table 10, 10′, 10″, a movable lower table 9, 9′, 9″ may be used.

Instead of two cylinders 16, one cylinder or more than two cylinders may be used for the drive.

The cylinders 16 may be located at any suitable positions on the upper table 10.

The cylinders may have designs of varying strengths.

The position and pressure of the cylinders may be individually regulated in order to compensate for unevenness of the packaging materials or local material deficiencies.

For the position control, a displacement control system (regulating the flow into the cylinders by a variable displacement pump) or a resistance control (the flow into the cylinders is regulated by valves) may be used.

One alternative is the use of several mechanical press drive units that are synchronized to each other.

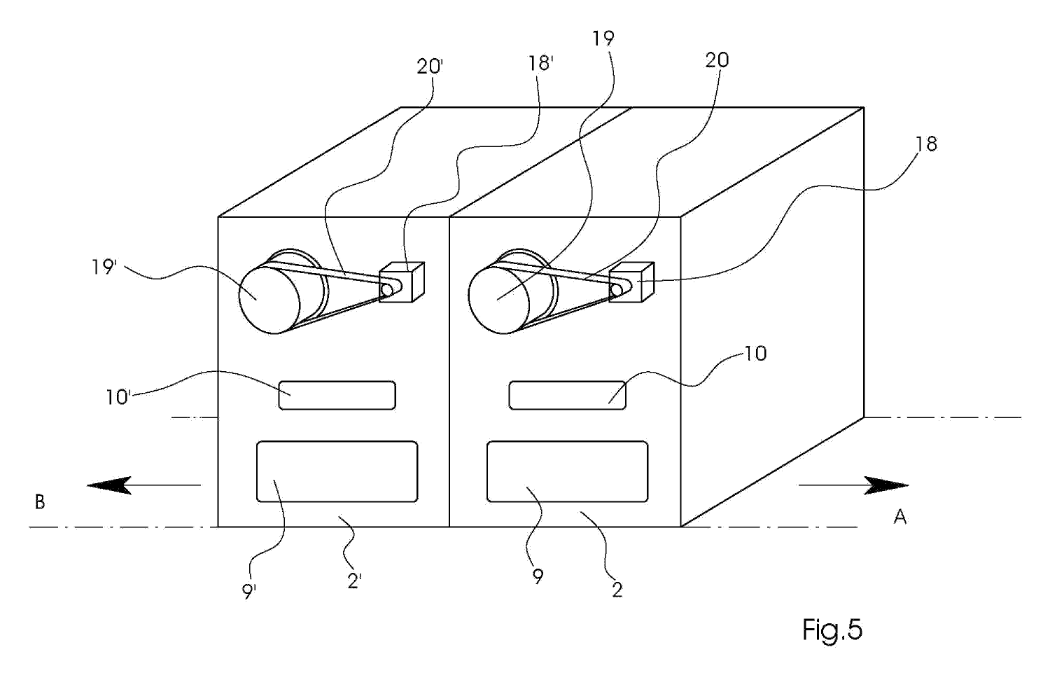

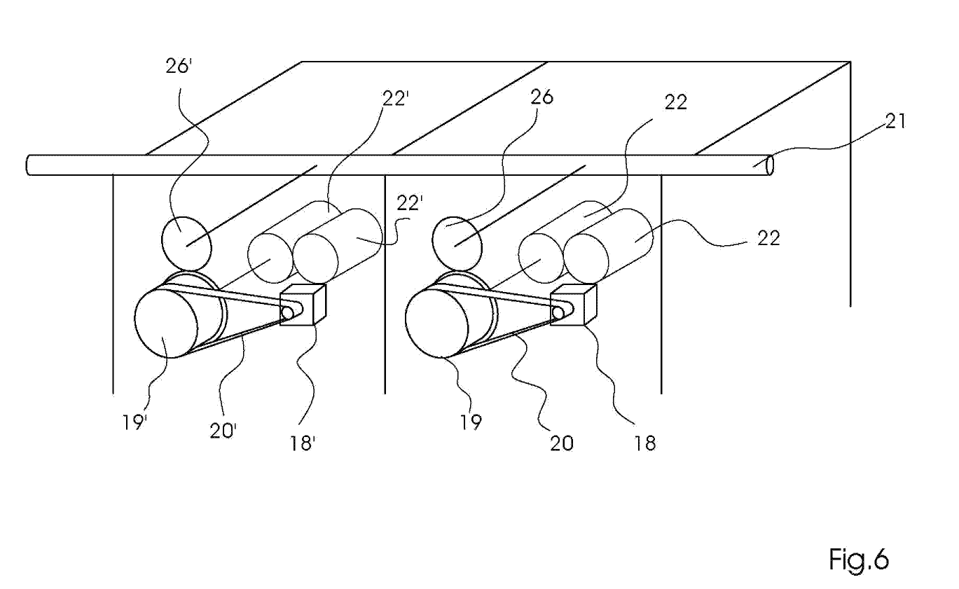

FIGS. 5 and 6 show a schematic representation of mechanically operated punching and embossing stations 2 and 2′, each of which includes any arbitrary number of stations disposed upstream in the direction of arrow A or downstream in the direction of arrow B. The punching and embossing stations 2 and 2′, and any stations upstream or downstream from them, include one press drive 19, 19′ for each movable upper table 10, 10′, including, not further illustrated, a disk flywheel coupled and connected to the gearing which moves the upper table 10, 10′ via eccentric shafts 22, 22′. The press drive is driven, for example, across a reduction gearing 20, 20′ from a drive motor 18, 18′. The power flows directly from the disk flywheel to the platen. A small gearing 26, 26′ is provided to synchronize the individual press drives, which does not transmit any major power flow and joins the press drives 19, 19′ to a king shaft 21, e.g., for synchronization.

Alternatively, synchronization may be provided by individual drive motors for the disk flywheels, which are controlled as servo-drives.

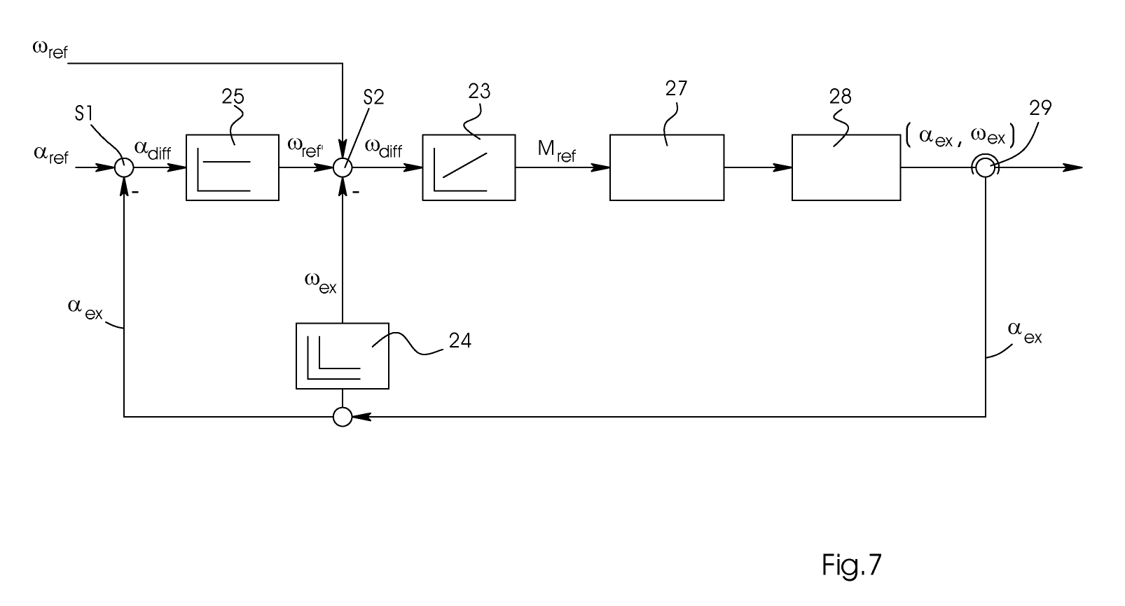

FIG. 7 shows the feedback control circuit for actuating the press drives. As shown in FIG. 7, both a rotary speed control and a position control are performed.

The feedback control circuit shown in FIG. 7 is used to adjust the control variable αₑₓ to the setpoint α_{ref}. The quantity ω_{ref} is used here in the form of a setpoint lock-on to avoid position errors. ω_{ref} is the first derivative of the setpoint α_{ref} with respect to time.

The comparison of αₑₓ and α_{ref} is performed by a subtraction element. A subsequent proportional element 25 amplifies the control deviation α_{diff} and adds it as ω_{ref′} to ω_{ref}. From this sum, ωₑₓ is subtracted to generate a control deviation ω_{diff}. This control deviation ω_{diff} is further processed by, for example, a PI-element 23, into a motor torque setpoint M_{ref} in order to avoid permanent control deviations. The transfer functions 27, 28 symbolize the dynamic behavior of a current controller (motor controller) and the mechanical system being governed. The movement condition (αₑₓ and ωₑₓ) is detected by a position sensor 29. The output of this position sensor is the position value αₑₓ. αₑₓ is feedback to the subtraction element S1 for the comparison with α_{ref}. Moreover, the time derivative of α_{ref} is generated in the differentiator 24, so that it can be provided as ω̅ₑₓ to the subtraction element S2.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A sheet punching and embossing machine for the processing of sheets comprising:
a plurality of processing stations, each including one die fixed to a frame of the machine and one movable die; and
a transport device arranged to transport the sheets through each of the plurality of processing stations; wherein
the movable dies are moved by separate drive units, and the separate drive units are actuated separately by a position governing circuit such that a stroke movement of the movable dies of each of the plurality of processing stations can be individually adjusted.

2. The sheet punching and embossing machine according to claim 1, wherein the separate drive units are hydraulic cylinders.

3. The sheet punching and embossing machine according to claim 2, wherein pistons of the hydraulic cylinders are secured on the movable die and cylinders of the hydraulic cylinders are secured on the frame.

4. The sheet punching and embossing machine according to claim 1, wherein a setpoint for movement of the movable die is individually determined as a function of a global machine angle, which is produced by a setpoint generator.

5. The sheet punching and embossing machine according to claim 1, wherein each of the movable dies of the plurality of processing stations is secured to an upper table of the plurality of processing stations.

6. The sheet punching and embossing machine according to claim 1, wherein each of the movable dies of the plurality of processing stations is secured to a lower table of the plurality of processing stations.

7. The sheet punching and embossing machine according to claim 1, wherein each of the movable dies is moved by at least one hydraulic cylinder.

8. The sheet punching and embossing machine according to claim 1, wherein the movable died are moved by a plurality of hydraulic cylinders.

9. The sheet punching and embossing machine according to claim 8, wherein the plurality of cylinders have different strengths.

10. The Sheet punching and embossing machine according claim 8, wherein the position and pressure of the plurality of cylinders are individually controlled.

11. The sheet punching and embossing machine according to claim 1, wherein a displacement control is provided to control the position of each of the movable dies of the plurality of processing stations.

12. The sheet punching and embossing machine according to claim 1, wherein a resistance control is provided to control the position of each of the movable dies of the plurality of processing stations.

13. The sheet punching and embossing machine according to claim 1, wherein the movable dies are each driven by a disk flywheel drive.

14. The sheet punching and embossing machine according to claim 13, wherein flow of power is coupled from the disk flywheel drive directly to the movable dies.

15. The sheet punching and embossing machine according to claim 14, wherein a small gearing is provided to synchronize the separate drive units.

16. The sheet punching and embossing machine according to claim 15, wherein the small gearing is defined by a king shaft.

17. The sheet punching and embossing machine according to claim 14, wherein the synchronization is performed via individual drive motors for the disk flywheels, which are controlled as servo drives.

18. The sheet punching and embossing machine according to claim 1, wherein at least one of the movable dies is mechanically driven.

19. The sheet punching and embossing machine according to claim 1, wherein at least one movable die is hydraulically driven.

20. The sheet punching and embossing machine according to claim 1, wherein the transport device includes at least one linear drive.

21. The sheet punching and embossing machine according to claim 1, wherein the plurality of processing stations includes at least one punching and/or embossing station.
